(19) United States
(12) Patent Application Publication
(10) Pub. No.: US 2007/0282636 A1
(43) Pub. Date: Dec. 6, 2007

(54) Document Deficiency and Workflow Management System

(75) Inventors: Stephen Sauk, Thorndale, PA (US); Andres Hernandez, Downington, PA (US); Frank W. Racis, Spring City, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/696,955

(22) Filed: Apr. 5, 2007

Related U.S. Application Data
(60) Provisional application No. 60/804,013, filed on Jun. 6, 2006.

(51) Int. Cl. G06Q 50/00

(52) U.S. Cl. 705/3

(57) ABSTRACT

A healthcare document processing system processes a document deficiency preventing a patient record from being designated complete. The system includes a repository including deficiency chain data identifying, for a particular patient multiple document deficiencies, individual document deficiency type, an order for addressing the document deficiencies and a process type to be used in processing an individual deficiency type for providing a completed patient record. A data processor automatically associates multiple delinquency dates with corresponding multiple document deficiencies identified by chain data for the particular patient and an individual delinquency date identifies a date by which an associated individual document deficiency is to be resolved.

This is a non-provisional application of provisional application Ser. No. 60/804,013 by A. Hernandez et al. filed Jun. 6, 2006.

### FIELD OF THE INVENTION

This invention concerns a system for processing a document deficiency preventing a patient record from being designated complete involving monitoring delinquency dates identifying when individual document deficiencies are to be resolved.

### BACKGROUND INFORMATION

Hospital Healthcare Information Management (HIM) departments are responsible for ensuring that a patient medical record is complete and accurate. HIM departments ensure there are no documents missing from a patient record and that the documents that are present are complete, accurate and signed if they need to be signed. HIM departments follow guidelines dictated by accreditation organizations such as the JCAHO (Join Commission on Accreditation of Healthcare Organizations) to ensure that patient records are complete. One of those guidelines dictates that certain documents need to be present in a patient record within a particular amount of time, e.g. A History and Physical document needs to be present in a patient record within 24 hours of the patient being admitted to a hospital.

Known systems employed by HIM personnel need to review a patient record more than once to create data indicating document deficiencies related to a particular document and individual document deficiencies have different aging settings. For example, HIM personnel may create a document deficiency indicating that a document needs to be present in a patient record within a particular first amount of time such as 24 hours from admission (a first aging setting). Subsequently, HIM personnel may create a document deficiency indicating that the document needs to be signed within a different second amount of time such as within 30 days from admission (a second aging setting). Known systems allow HIM departments to require that a document be present in a patient record within a specific amount of time, such as 24 hours from the patient being admitted to a hospital but fail to support different document deficiency aging settings. A system according to invention principles addresses this problem and related problems.

### SUMMARY OF THE INVENTION

Known systems fail to automatically require that a document needs to be present in a patient record within a particular amount of time such as 24 hours from admission and the document needs to be signed within a different time frame such as 30 days from the patient being admitted. A healthcare document processing system processes a document deficiency preventing a patient record from being designated complete. The system includes a repository including deficiency chain data identifying, for a particular patient multiple document deficiencies, individual document deficiency type, an order for addressing the document deficiencies and a process type to be used in processing an individual deficiency type for providing a completed patient record A data processor automatically associates multiple delinquency dates with corresponding multiple document deficiencies identified by chain data for the particular patient and an individual delinquency date identifies a date by which an associated individual document deficiency is to be resolved.

### BRIEF DESCRIPTION OF THE DRAWING

FIG. 1 shows healthcare document processing system for processing a document deficiency preventing a patient record from being designated complete, according to invention principles.

FIG. 2 shows a user interface image menu used to create a deficiency chain in a HIM application, according to invention principles.

FIG. 3 shows a user interface image menu used to create a document deficiency aging setting for a given deficiency chain link, according to invention principles.

FIG. 4 shows a user interface image window indicating how a signature link is created, according to invention principles.

FIG. 5 shows a user interface image window illustrating creation of a deficiency for a record that uses special aging criteria defined in a deficiency chain, according to invention principles.

FIG. 6 shows a user interface image window illustrating aging for a particular deficiency based on factors including an admission date and the number of days to complete a deficiency, according to invention principles.

FIG. 7 shows a user interface image window illustrating a document signature deficiency and the details about the signature deficiency, according to invention principles.

FIGS. 8 and 9 show user interface image windows enabling update of a deficiency aging type, according to invention principles.

FIGS. 10, 11 and 12 show user interface image windows enabling a user to override a due date of a deficiency if the aging type defined in the deficiency chain link does not fit a particular situation, according to invention principles.

FIG. 13 shows a flowchart of a process for processing a document involving document deficiency management, according to invention principles.

### DETAILED DESCRIPTION OF INVENTION

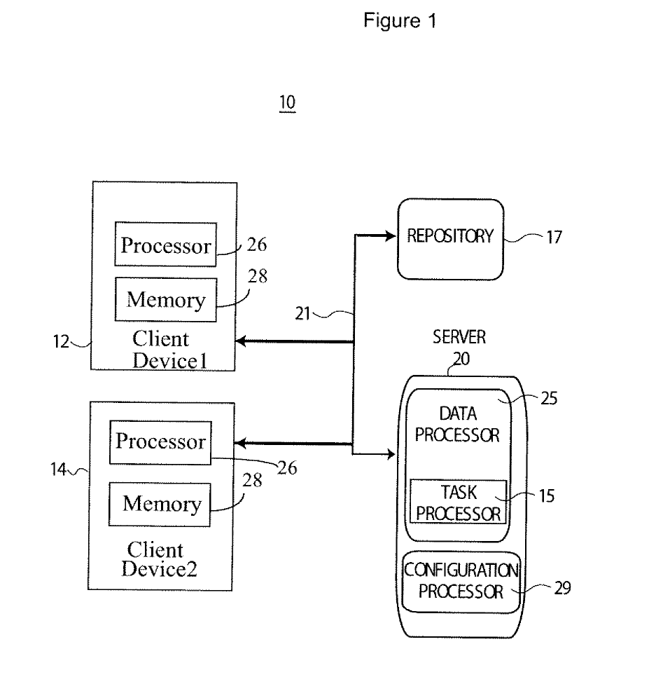

FIG. 1 shows a document processing system 10 involving document deficiency management. The system identifies document deficiencies, manages and chains document deficiency indicators together to support workflow control and automates a document completion process. In healthcare it is important to maintain documentation of good quality and this typically involves a review process to ensure that documentation is available and correct. Maintenance of documentation involves monitoring record completion and includes a task sequence workflow to collect documents that are relevant to individual health records and workflows (user or task performed task sequences) to validate that document information is correct and complete and not omitting vital data. The system enables individual deficiencies in a chain of deficiencies to be associated with corresponding different individual delinquency dates (aging criteria) indicating when an associated deficiency needs to be completed. Thereby the system can beis configureabled to require a document such as a patient History and Physical document be present in a medical record within 24 hours of the patient being admitted to the hospital. Additionally, the system can beis configurable configured to require a clinician to sign the same document within 30 days of the admission date is configurable to require that a document such as a patient History and Physical document be present in a patient medical record within 24 hours of the patient being admitted to a hospital and to require a clinician has 30 days from the admission date to sign it.

A record may comprise one or more documents and the term “record” may be used interchangeably with the term “document” and “folder”. A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprise any combination of, hardware, firmware, and/or software.

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UT), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure. A document or record comprises a compilation of data in electronic or paper form.

The term complete refers to a condition achieved by a folder or document when the information contained therein is verified to be accurate and whole. In the case of a document, this means when there is no missing information relevant and necessary to the document and the contained information is substantially accurate. A folder is complete when expected or required documents exist for that folder and documents contained in the folder are complete. A deficiency refers to some condition that makes a folder or document incomplete. For example, a folder may be missing an expected or required document or a document may be missing information or contain inaccurate information. A deficiency chain refers to an ordered series of data indicating deficiencies used to define a task sequence (a workflow) performed by a worker or system to control a record completion process. A deficiency chain comprises data indicating a sequence of deficiencies that needs to be addressed in order to ensure that a record or document is complete. A deficiency chain link refers to a single deficiency in an existing deficiency chain. It is associated with data settings that allow a deficiency created from a given link to age in a predefined way. An individual link in a chain can have different aging type criteria. A document type (an attribute of a document) is an identifier that is used to group together documents that have the same functional characteristics and allows the logical and physical grouping of documents based on their content. Document processing system 10 is configurable to perform particular actions based on document type. A Document identifier (document Id) is an internal identifier used to uniquely identify a single document in a document processing system.

A folder is a container used to organize documents Folders can contain zero or more documents and zero or more subfolders. A folder may be considered a parent of documents and subfolders contained within it. The term incomplete is the antonym of complete. The invention principles are applicable to any business object (i.e. an object in any industry such as an employee in the human resources industry or an account in the banking industry), but is described for exemplary purposes in the context of business objects of documents and records as defined below.

An Aging type defines how a deficiency will ages, is concerns a number of days that a deficiency has aged and a HIM system has different aging types which are associated with Discharge date, Admit date, Allocation date, and Manual override, for example. Further, delinquent days are the number of days that a deficiency can age before it becomes delinquent. A delinquent deficiency is a deficiency that has aged more than an allowed limit set by a combination of aging type and delinquent days, e.g., if a “History and Physical” document needs to be present 24 hours after a patient is admitted, the Aging type is set to “Admit date” and the “Delinquent days” are set to one. After one day from the admit date, the deficiency that requires presence of the “History and Physical” indicates delinquency and a clinician responsible is notified of a need to complete a deficiency.

FIG. 1 shows document processing system 10 for performing document deficiency management. Document processing system 10 includes client devices 12 and 14, repository 17 and server 20. Repository 17 includes deficiency chain data identifying, for a particular patient multiple document deficiencies, individual document deficiency type, an order for addressing the document deficiencies and a process type to be used in processing an individual deficiency type for providing a completed patient record. Server 20 includes data processor 25 that automatically associates multiple delinquency dates with corresponding multiple document deficiencies identified by chain data for the particular patient. An individual delinquency date identifies a date by which an associated individual document deficiency is to be resolved. Configuration processor 29 executes a configuration application enabling a user to configure a deficiency chain and an individual deficiency aging type and associated number of delinquent days allowed for completion of the individual deficiency. Configuration processor 29 includes task (workflow) processor 15 executing a task processing (workflow) application. The system 10 devices are interconnected and bidirectionally communicate via network 21 such as a LAN (Local Area Network) or other type of network. A client device 12 or 14 includes processor 26 and memory unit 28 and may comprise a personal computer, for example. A user is able create, maintain and manage individual deficiency aging type and associated number of delinquent days as well as deficiency chain data using configuration processor 29 via one or more user interface images displayed on client device 12 or 14. The document processing system 10 may be used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Workflow processor 15 processes data to determine tasks to add to a task list, remove from a task list or modifies tasks incorporated on, or for incorporation on, a task list. A task list is a list of tasks for performance by a worker or device or a combination of both. Workflow processor 15 may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps (e.g., comprising a deficiency chain) including one or more, of start, wait, decision and task allocation steps for performance by a device and or worker, for example. An event is an occurrence affecting operation of a process implemented using a process definition.

Workflow processor 15 comprises a Workflow Management System, a software system that manages processes. It includes a process definition function that allows users to define a process that is to be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists and a procedure for allocating and assigning tasks to specific users or specific teams. A document or record comprises a compilation of data in electronic form and is the equivalent of a paper document and may comprise a single, self-contained unit of information. It may consist of one or more “pages” of information bound together as a unit. The pages may be stored in any digital format as lone as the stored pages can be rendered into a human readable presentation.

Healthcare Information Management departments in health care organizations have specific guidelines to ensure that patient records are complete. A subset of the guidelines determines an amount of time available to a clinician to ensure that a document is either complete or present in the patient record. Known deficiency managements systems typically allocate the same amount of time to complete any deficiency that is determined through a single setting and for two deficiencies require creation of two separate deficiency items in a two step process. Known deficiency management systems fail to accommodate exceptions to this amount of time, e.g., indicating the time available to a clinician to ensure that a document is present in a patient record such as requiring a History and Physical document be present in a patient record within 24 hours of being admitted to a hospital.

In contrast, system 10 provides a user with flexibility to comply with exceptions concerning an amount of time available to a clinician to complete a deficiency of a patient record. Further, system 10 units 25 and 29 enable a user (or system) to set the amount of time that a clinician has to complete a deficiency during creation of the deficiency or after it has been created by updating the amount of time. System 10 advantageously combines a deficiency aging function with a deficiency chain function to provide automatic deficiency management without human intervention as well as to improve workflow and workflow configuration. A Deficiency Chain advantageously supports a workflow for ensuring that patient records are complete. Successful completion of a deficiency may lead to a successive deficient condition, e.g., an initial deficiency condition of a patient folder results from a document being missing from a patient medical record. However, once the document is incorporated in the patient record, a further deficiency is initiated indicating the document needs to be signed. System 10 advantageously reduces the amount of time to analyze records because documents that are required to be present in a patient record within a predetermined time period and also need to be signed within a different time period may be analyzed by a HIM department staff once.

An individual deficiency indicator identifying a record or document is potentially incomplete is created in system 10 and is incorporated in a deficiency chain as a deficiency chain link. A created deficiency indicator contains information identifying a type of deficiency, a person or healthcare role responsible for completing the deficiency and how much time the responsible party has to complete the deficiency. In one embodiment, the aging information is stored in a deficiency chain link definition making system 10 flexible and allowing individual links in a deficiency chain to have a different aging type if needed.

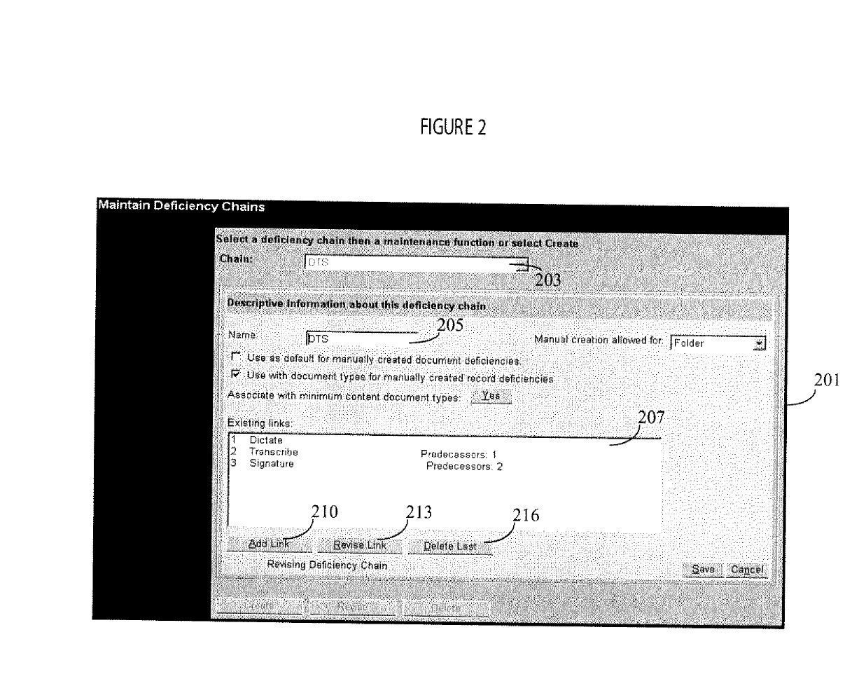

FIG. 2 shows a user interface image menu used to create a deficiency chain in a HIM application. A deficiency chain controls workflow to achieve record completion and denotes steps (deficiency chain links) required to complete a document or patient record and tracks the progress of those steps. Image window 201 illustrates creation of a DTS chain 203 having a name (DTS) 205 comprising individual links shown in area 207. Links in area 207 may be added, edited and deleted via menus accessed by buttons 210, 213 and 216 respectively. The first DTS chain link is called Dictate, the second link is called Transcribe and the third link is called Signature. A deficiency chain directs workflow in a HIM application by controlling the order in which individual deficiency chain links are addressed before a record or document may be declared free of deficiencies and complete. In DTS chain 203, a Dictate deficiency chain link needs to be addressed before a document concerned may be transcribed and the document needs to be transcribed before it can be signed.

System 10 includes a deficiency chain function and deficiency aging function enabling a user to determine an aging type and delinquent days for individual links in a deficiency chain. The system facilitates users of a Healthcare Information Management (HIM) system in complying with JCAHO (Joint Commission on Accreditation of Healthcare Organizations) regulations, and also provides users with an ability to have different aging settings for each link in a deficiency chain. Thereby a single deficiency chain (with one step) can require that a document be present in a patient record within 24 hrs of being admitted and require that the document be signed within 30 days of the patient being discharged, for example.

An individual deficiency chain link data item contains detailed information about a deficiency that is to be created from a link definition. Specifically, a deficiency chain link data item indicates, a type of deficiency that is to be created from a link definition, predecessors or deficiencies that need to be completed before a current deficiency can be completed, how a deficiency is to be positioned in a document and a method for assigning a responsible party to complete a deficiency that is created from a link definition. An aging type and associated number of delinquent days are also assigned to a deficiency.

The chain link data item information provides a HIM application with the flexibility to assign different aging types to different deficiencies that are created from the same deficiency chain. So a user may create a DTS chain that requires that a document be present in the patient record within 24 hours of being admitted to a hospital, but that does not have to be signed until 30 days after the patient is discharged from the hospital. Individual deficiency chain link aging types (Admit date, Allocation date, discharge date and the current system setting) are associated (except for the current system setting) with a user or system set number of days before a deficiency becomes delinquent. So if a document needs to be present in a patient record within 24 hours of the patient being admitted to the hospital, a user configures an aging type for a Dictate link of the chain to be Admit date and sets a number of delinquent days to one. The Transcribe link is similarly configured since both Dictate and Transcribe deficiencies need to be completed to ensure that the document gets filed in a patient record. The Signature deficiency link may be subsequently completed and can have an aging type of Discharge Date with an associated number of delinquent days set to 30.

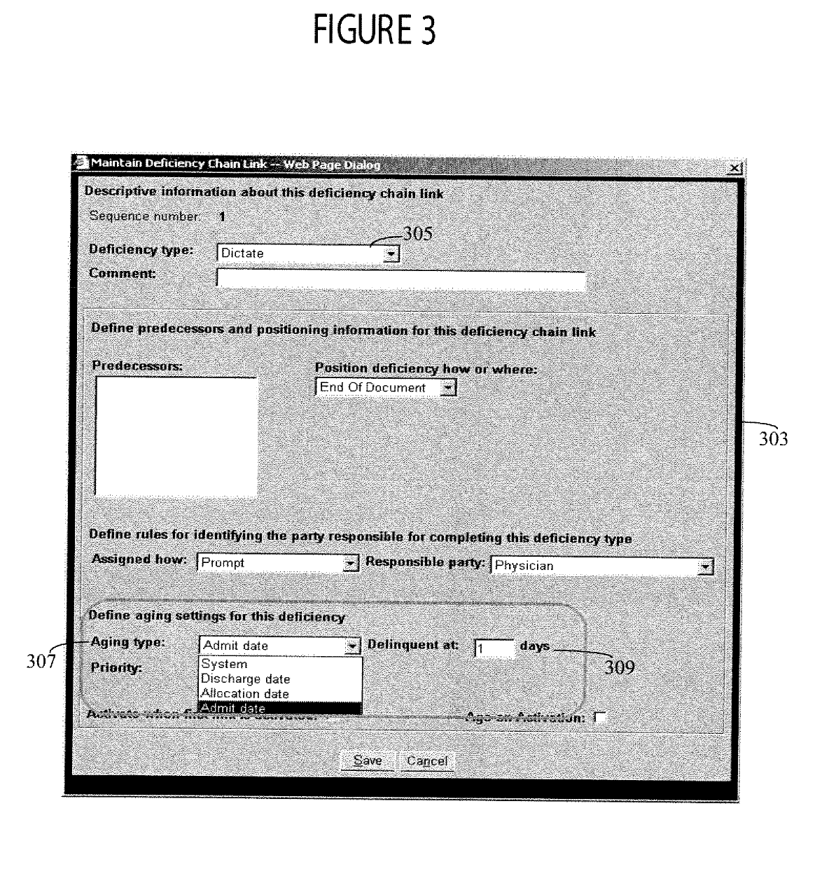

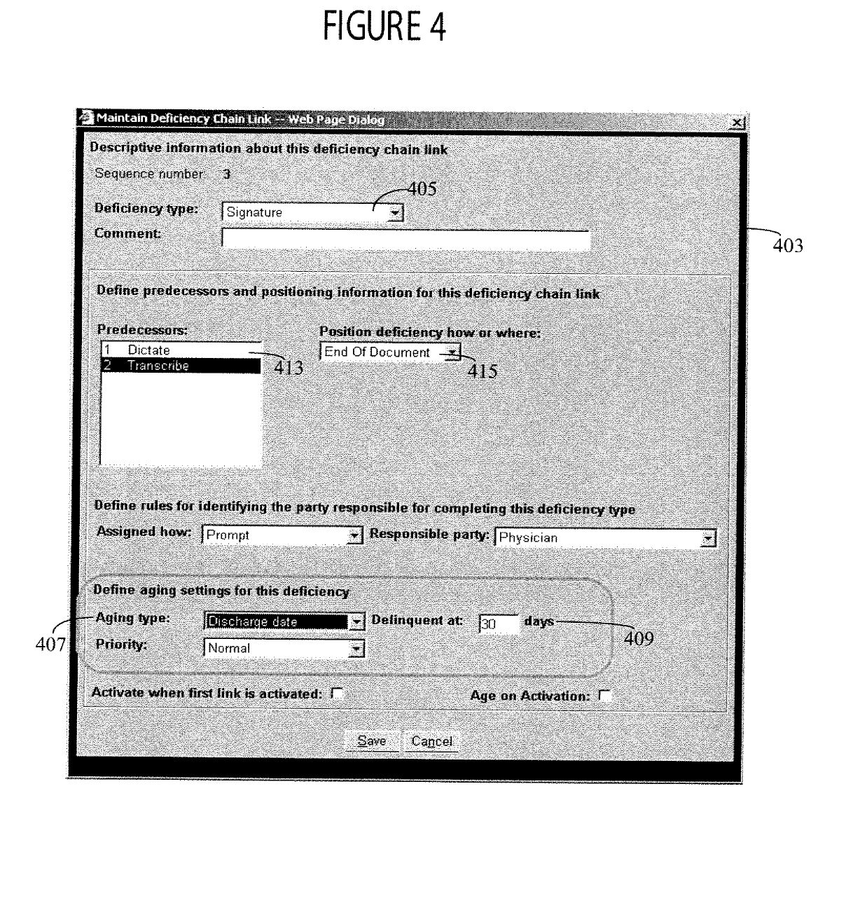

FIG. 3 shows user interface image menu 303 used to create a document deficiency aging setting for a given deficiency chain link. A Dictate deficiency chain link 305 is created with an aging type 307 set to Admit date and a number of days that it takes for the deficiency to become delinquent 309 Set to one. In the same deficiency chain a user may also set an aging type for the signature deficiency to be Discharge date with 30 days before it becomes delinquent. FIG. 4 shows user interface image window 403 indicating how a signature link is created. A Signature deficiency chain link 405 is created with an aging type 407 set to Discharge date and a number of days that it takes for the deficiency to become delinquent 409 set to thirty. Predecessor links (Dictate and Transcribe) are identified in area 413 and item 415 indicates a position al which the deficiency is to be applied in the document concerned (End of Document).

System 10 uses a DTS deficiency chain to indicate that a patient record needs to have a document dictated within one day of a patient being admitted to a health care organization, and once the document has been dictated, the user has 30 days from the patient being discharged to sign the document. The different Dictate and Signature links have different aging criteria and the document deficiency aging in data processor 25 and configuration processor 29 enables a user to set aging criteria during creation of the DTS chain. The Transcription link typically has the same aging criteria as the Dictate link as the document is not incorporated in a patient record until it is transcribed.

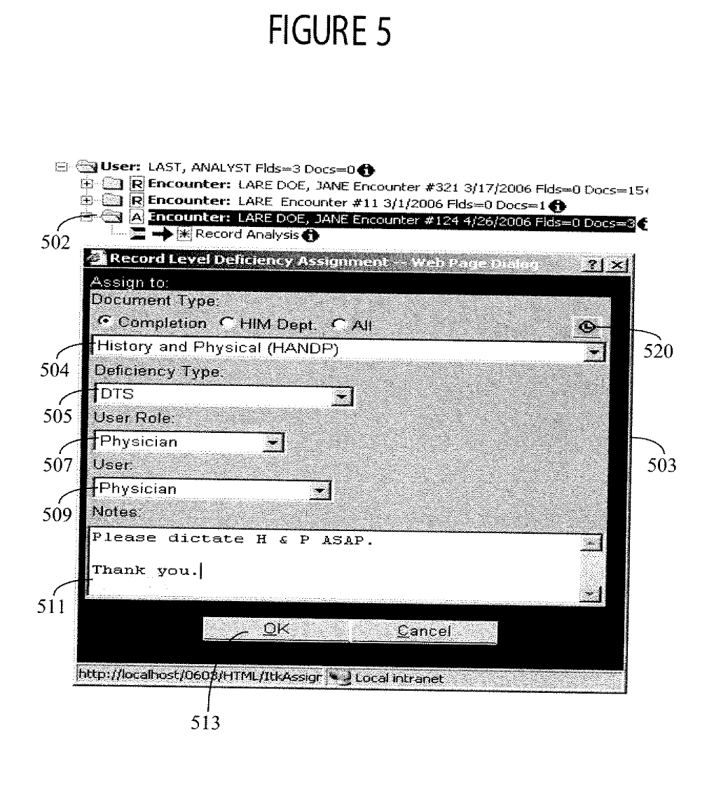

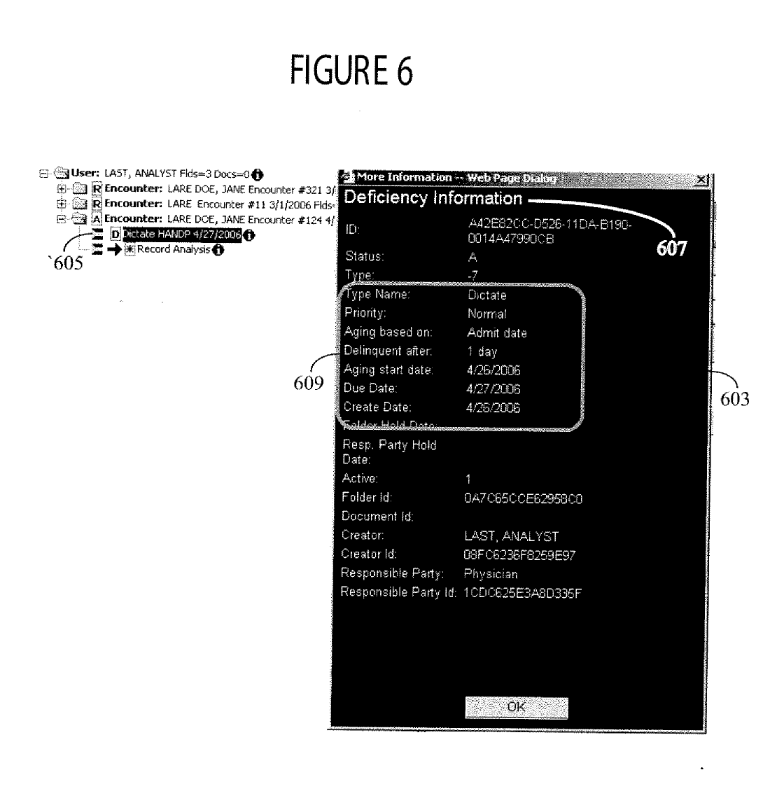

FIG. 5 shows a user interface image window 503 illustrating creation of a deficiency in a record that uses special aging criteria defined in a DTS deficiency chain, for example. A user creates a deficiency of the type DTS and the aging for each link in the chain (Dictate, Transcribe, and Signature) is set according to a definition of the DTS deficiency chain. In response to a visit (encounter) indicated in item 502, a user creates a DTS deficiency type chain 505 for a History and Physical document 504 for completion by a user 509 occupying a role 507 (physician). The deficiency (Dictate) is indicated in area 511 and is created in response to user selection of button 513. In response to user selection of icon 520 FIG. 5, user interface image window 603 of FIG. 6 is displayed on workstation 12. Image window 603 illustrates deficiency information 607 including aging data 609 for a particular (Dictate) deficiency indicated in data item 605. Aging data 609 identifies deficiency type name (here Dictate), a priority (normal), aging type (based on admit date), a number of delinquent days to complete a deficiency (one day as determined in the DTS deficiency chain), an aging start date, a deficiency completion due date and a deficiency creation date.

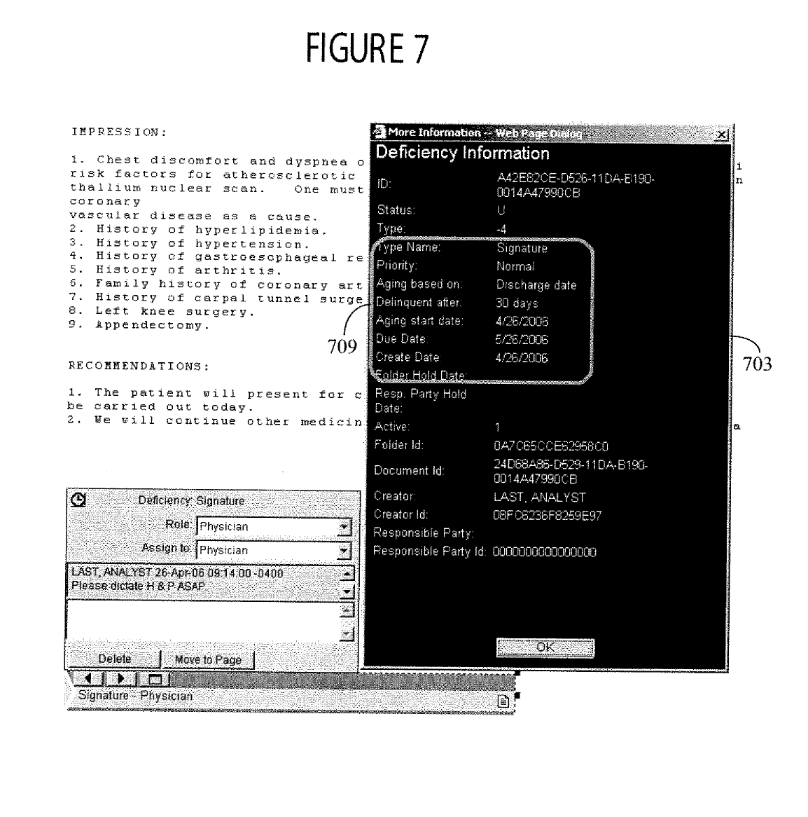

In response to the document being acquired by system 10, the Dictate and Transcribe deficiencies are completed and the signature deficiency is associated with the document. FIG. 7 shows user interface image window 703 illustrating a document signature deficiency and the details about the signature deficiency. Aging data 709 identifies deficiency type name (here Signature), a priority (normal), aging type (based on discharge date), a number of delinquent days to complete a deficiency (thirty days as determined in the DTS deficiency chain), an aging start date, a deficiency completion due date and a deficiency creation date. System 10 automatically associates two deficiencies (e.g., Dictate and Signature) with different aging criteria without manual intervention using a DTS deficiency chain.

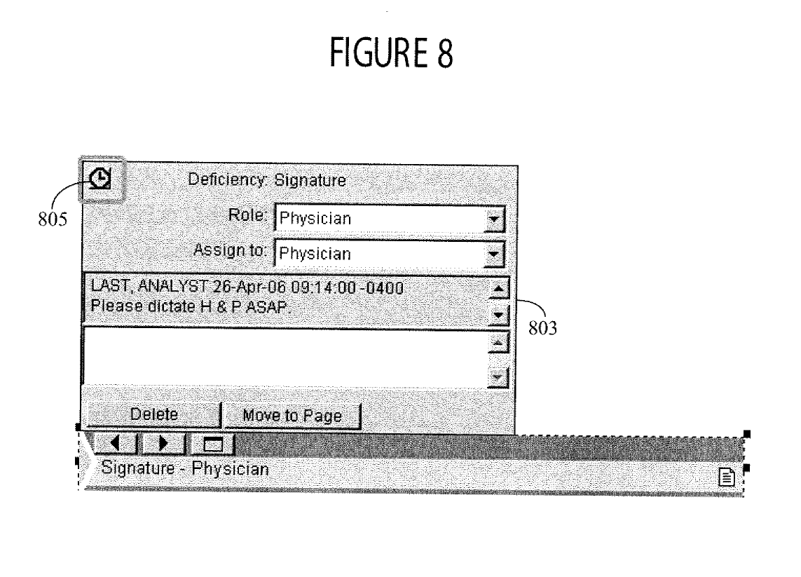

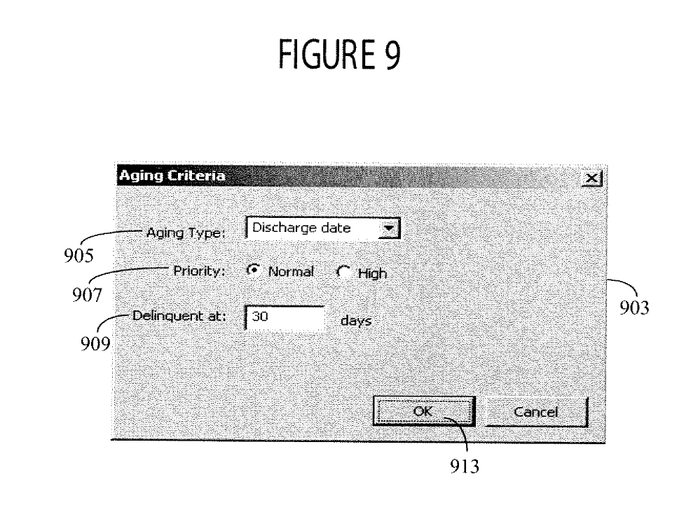

FIGS. 8 and 9 show user interface image windows 803 and 903 respectively, enabling a user to update a deficiency aging type. In order to update a deficiency aging type a user selects icon 805 in user interface image window 803 to display user interface image window 903. Image window 903 enables a user to change aging type 905 and priority 907 of a deficiency and a number of days 909 that it takes for the deficiency to become delinquent. System 10 enables creation of a deficiency chain in which one or more links can have different aging criteria and supports update of the aging criteria of the deficiency. System 10 supports automatic compliance with existing regulations and associated documentation by departments in healthcare organizations. System 10 advantageously enables different deficiencies of a record or document to automatically have different aging settings with little or no manual intervention and is applicable to any area where efficient document workflow is of value. HIM departments use system 10 to reduce the number of times personnel look at a patient record by reducing the need to manually and individually create deficiencies with different aging criteria.

In response to a deficiency chain (e.g., a DTS chain) being used to manage and create deficiencies for a patient record, system 10 automatically calculates due dates of individual deficiencies based on the aging type defined for the individual deficiency links of the chain. So if an aging type is based on admit date, system 10 acquires the admit date of the patient and adds the necessary number of permissible delinquent days to calculate a due date of the deficiency. If the admit date or discharge date are not valued at the time the deficiency chain is used to create deficiencies of a patient record (e.g., the patient has not been discharged while deficiencies are being created using discharge date as its aging type) the due date of the deficiency is not valued. Once the patient is discharged and the discharge date is valued, system 10 automatically finds the deficiencies for that patient and updates their associated due dates using the discharge date to calculate the due date. System 10 similarly also awaits valuation of an admit date before automatically finding the deficiencies for that patient and updating their associated due dates.

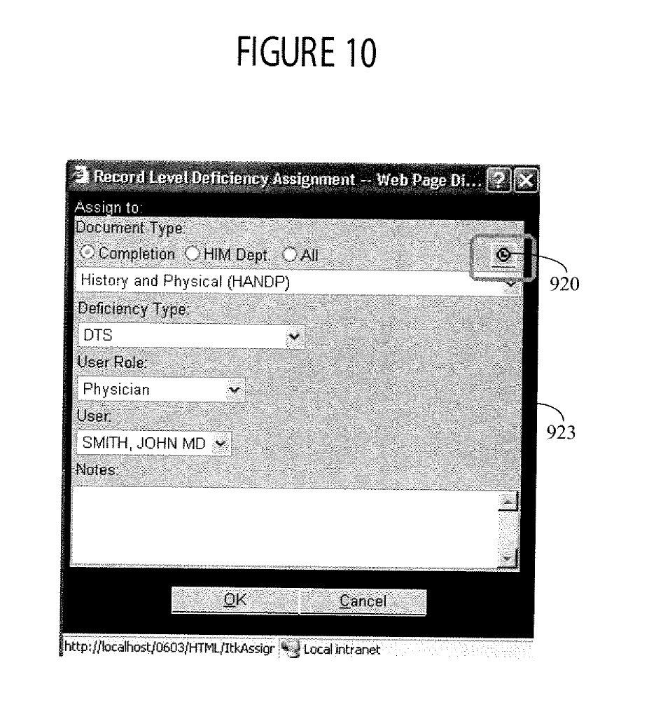

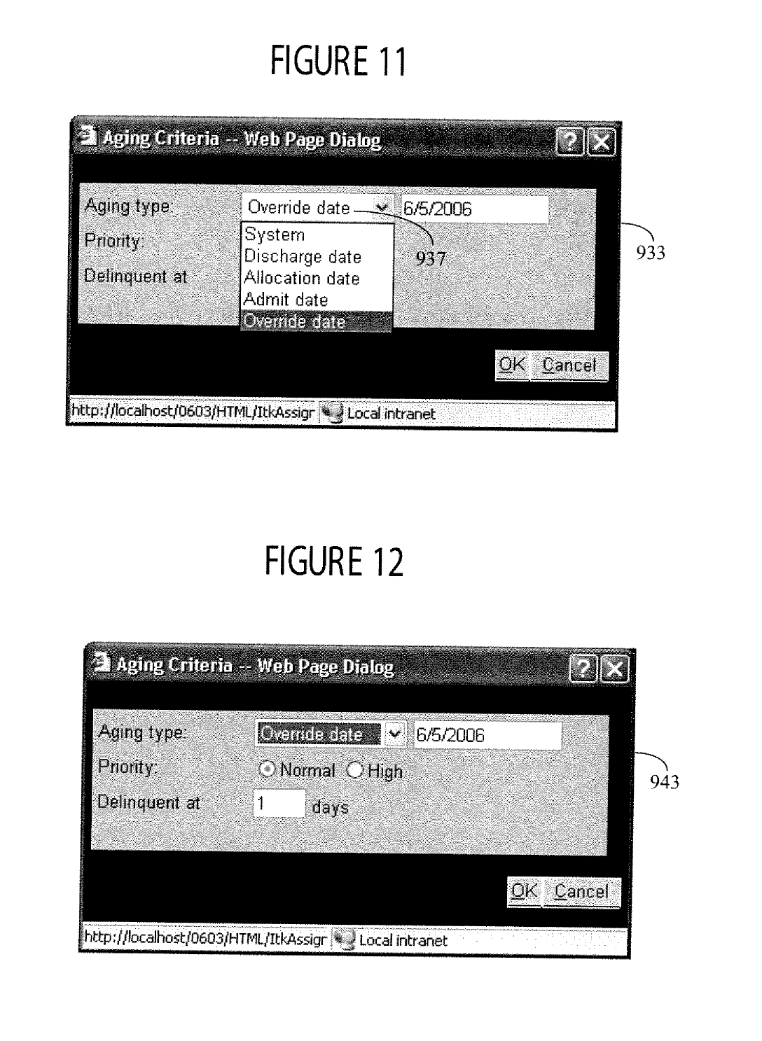

FIGS. 10, 11 and 12 show user interface image windows provided by system 10 enabling a user to override a due date of a deficiency if the aging type (e.g., based on allocation date, discharge date, or admit date) determined in the deficiency chain link does not fit a particular situation. In order to override a due date of a deficiency, a user creating the deficiency selects icon 920 in image window 923 of FIG. 10. In response a user is presented with the Aging Criteria dialog window 933 of FIG. 11 that enables the user to override the aging criteria defined in the deficiency chain link to accommodate the needs of the user and a particular situation. A user employs Aging Criteria dialog window 933 to select an aging type from different aging types available such as Admit date, Discharge Date, Allocation Date, Manual Override, and System Aging in option list 937. Allocation date is a date the deficiency is being assigned to a responsible party to complete the deficiency, System Aging bypasses any aging type determined in a deficiency chain link and uses the overall system aging setting and Override date allows a user to enter an arbitrary date by which a deficiency needs be completed. The aging options available to a user when overriding an aging type of a deficiency provide flexibility. Image window 943 of FIG. 12 illustrates user selection of an Override Date as aging type, with normal priority and with one day as the associated number of permissible delinquent days.

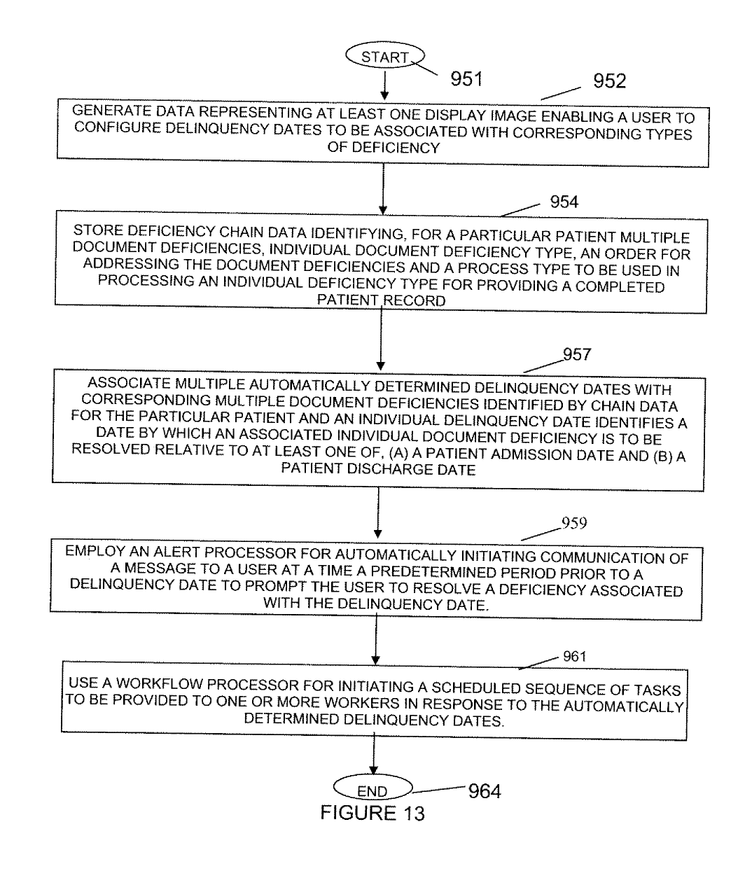

FIG. 13 shows a flowchart of a process for processing a document involving document deficiency management. In step 952 following the start at step 951 a user interface processor in workstation 12 generates data representing at least one display image enabling a user to configure delinquency dates to be associated with corresponding types of deficiency. Data processor 25, in step 954 stores deficiency chain data in repository 17. The chain data identifies, for a particular patient multiple document deficiencies, individual document deficiency type, an order for addressing the document deficiencies and a process type to be used in processing an individual deficiency type for providing a completed patient record. In step 957, data processor 25 automatically (or in one embodiment, in response to user manual action) associates multiple automatically determined delinquency dates with corresponding multiple document deficiencies identified by chain data for the particular patient. An individual delinquency date identifies a date by which an associated individual document deficiency is to be resolved relative to at least one of, (a) a patient admission date and (b) a patient discharge date. Data processor 25 automatically generates a delinquency date in response to a deficiency type associated with a patient admission date, a patient discharge date, a task allocation date or a system aging date. Data processor 25 automatically generates the delinquency date for a particular deficiency type based on a predetermined period from the patient admission date or the patient discharge date, for example. Further, the user interface provided by workstation 12 enables a user to enter data and to override an automatically generated delinquency date.

In step 959 an alert processor in data processor 25 automatically initiates communication of a message to a user at a time occurring a predetermined period prior to a delinquency date to prompt the user to resolve a deficiency associated with the delinquency date. Workflow processor 15 initiates a scheduled sequence of tasks to be provided to one or more workers in response to the automatically determined delinquency dates. Workflow processor 15 employs a workflow engine comprising a processor executing in response to predetermined process definitions (comprising chain data) that implement processes responsive to events and event associated data. The process of FIG. 13 terminates at step 964.

The system, processes and image displays of FIGS. 1-13 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may he implemented by those skilled in the art, without departing from the scope of the invention. A deficiency chain function and deficiency aging function enabling a user to determine an aging type and delinquent days for individual links in a deficiency chain is applicable to managing document completion in any field. Further, any of the functions and steps provided in FIGS. 1-13 may be implemented in hardware, software or a combination of both and may reside on one or more processing devices located at any location of a network linking the FIG. 1 elements or another linked network including another intra-net or the Internet.

What is claimed is:

1. A healthcare document processing system for processing a document deficiency preventing a patient record from being designated complete, comprising:
a repository including deficiency chain data identifying, for a particular patient a plurality of document deficiencies, individual document deficiency type, an order for addressing said document deficiencies and a process type to he used in processing an individual deficiency type for providing a completed patient record; and
a data processor for automatically associating a plurality of delinquency dates with a corresponding plurality of document deficiencies identified by chain data for said particular patient and an individual delinquency date identifies a date by which an associated individual document deficiency is to he resolved.

2. A system according to claim 1, including
a user interface enabling a user to enter data and to override an automatically generated delinquency date.

3. A system according to claim 1, wherein
said data processor automatically generates a delinquency date in response to a deficiency type associated with at least one of, (a) a patient admission date and (b) a patient discharge date.

4. A system according to claim 3, wherein
said data processor automatically generates said delinquency date for a particular deficiency type based on a predetermined period from said patient admission date or said patient discharge date.

5. A system according to claim 1, wherein
said data processor automatically generates a delinquency date in response to a deficiency type associated with at least one of, (a) a task allocation date and (b) a system aging date and
said data processor automatically generates said delinquency date for a particular deficiency type based on a predetermined period from said task allocation date or said system aging date.

6. A system according to claim 1, including
an alert processor for automatically initiating communication of a message to a user at a time a predetermined period prior to a delinquency date to prompt said user to resolve a deficiency associated with said delinquency date.

7. A system according to claim 1, including
a workflow processor for initiating a scheduled sequence of tasks to be provided to one or more workers compatible with said plurality of delinquency dates.

8. A healthcare document processing system for processing a document deficiency preventing a patient record from being designated complete, comprising:
a repository including deficiency chain data identifying, for a particular patient a plurality of document deficiencies, individual document deficiency type, an order for addressing said document deficiencies and a process type to be used in processing an individual deficiency type for providing a completed patient record; and
a data processor for associating a plurality of automatically determined delinquency dates with a corresponding plurality of document deficiencies identified by chain data for said particular patient and an individual delinquency date identifies a date by which an associated individual document deficiency is to be resolved relative to at least one of, (a) a patient admission date and (b) a patient discharge date.

9. A system according to claim 8, wherein
said data processor automatically determines said delinquency dates for said corresponding plurality of document deficiencies identified by chain data based on a predetermined period from said patient admission date or said patient discharge date.

10. A system according to claim 9, including
a workflow processor for initiating a scheduled sequence of tasks to be provided to one or more workers in response to said automatically determined delinquency dates.

11. A system according to claim 10, including
said workflow processor employs a workflow engine comprising a processor executing in response to predetermined process definitions that implement processes responsive to events and event associated data.

12. A system according to claim 9, including
a user interface processor for generating data representing at least one display image enabling a user to configure delinquency dates to be associated with corresponding types of deficiency.

13. A method for processing a document deficiency preventing a patient record from being designated complete, comprising the activities of:
storing deficiency chain data in a repository, said deficiency chain data identifying, for a particular patient a plurality of document deficiencies, individual document deficiency type, an order for addressing said document deficiencies and a process type to be used in processing an individual deficiency type for providing a completed patient record; and
associating a plurality of automatically determined delinquency dates with a corresponding plurality of document deficiencies identified by chain data for said particular patient and an individual delinquency date identifies a date by which an associated individual document deficiency is to be resolved relative to at least one of, (a) a patient admission date and (b) a patient discharge date.
